(19) United States
(12) Patent Application Publication
(10) Pub. No.: US 2023/0226460 A1
(43) Pub. Date: Jul. 20, 2023

(54) INFORMATION PROCESSING DEVICE, INFORMATION PROCESSING METHOD, AND RECORDING MEDIUM

(71) Applicant: SONY GROUP CORPORATION, TOKYO (JP)

(72) Inventors: TOMOHIKO GOTOH, TOKYO (JP); KAYOKO TANAKA, TOKYO (JP); KEIJIROH NAGANO, TOKYO (JP); SHINTARO TSUTSUI, TOKYO (JP)

(21) Appl. No.: 18/002,090

(22) PCT Filed: Apr. 30, 2021
(86) PCT No.: PCT/JP2021/017256

§ 371 Date: Dec. 16, 2022

(30) Foreign Application Priority Data
Jun. 24, 2020 (JP) 2020-108388

(51) Int. Cl. A63J 5/00; G06T 19/00; G02B 27/01

(52) U.S. Cl. CPC A63J 5/00; G06T 19/006; G02B 27/0172; G02B 2027/0178

(57) ABSTRACT

[Problem] It is preferable to provide a technology that allows input of a position at which a person who performs a predetermined performance should be present to be easily performed in advance so that the position at which the person should be present is confirmed later.

[Solution] Provided is an information processing device including a self-location acquisition unit configured to acquire self-position information of a mobile terminal in a global coordinate system linked to a real space, and a disposition position determination unit configured to acquire template data indicating a disposition pattern of at least one virtual object, and determine a position away from a current position of the mobile terminal indicated by the self-position information as a disposition position of a first virtual object in the global coordinate system, on the basis of the self-position information and the template data.

### TECHNICAL FIELD

The present disclosure relates to an information processing device, an information processing method, and a recording medium.

### BACKGROUND ART

In recent years, various technologies have become known to remedy situations that can arise at the time of formation practice. For example, a scheme for disposing a plurality of light emitting diodes (LEDs) on rails laid on a ceiling of a floor and dynamically projecting standing positions of a plurality of performers onto a stage from the plurality of LEDs has been proposed (see PTL 1, for example).

Further, a scheme for disposing identification (ID) tags on a stage, attaching ID readers to all performers, and displaying positions of the performers in real time on the basis of a reception state of the ID tags in the ID readers has been disclosed (see PTL 2, for example). This makes it possible for an acting instructor to confirm the quality of a formation by viewing the displayed positions of all performers.

### CITATION LIST

### Patent Literature

### [PTL 1]

JP 2018-019926 A

### [PTL 2]

JP 2002-143363 A

### SUMMARY

### Technical Problem

However, it is preferable to provide a technology that allows an input of a position at which a person who performs a predetermined performance should be present to be easily performed in advance so that the position at which the person should be present can be confirmed later.

### Solution to Problem

According to an aspect of the present disclosure, an information processing device including: a self-location acquisition unit configured to acquire self-position information of a mobile terminal in a global coordinate system linked to a real space; and a disposition position determination unit configured to acquire template data indicating a disposition pattern of at least one virtual object, and determine a position away from a current position of the mobile terminal indicated by the self-position information as a disposition position of a first virtual object in the global coordinate system, on the basis of the self-position information and the template data is provided.

According to another aspect of the present disclosure, an information processing method including: acquiring self-position information of a mobile terminal in a global coordinate system linked to a real space; and acquiring template data indicating a disposition pattern of at least one virtual object, and determining a position away from a current position of the mobile terminal indicated by the self-position information as a disposition position of a first virtual object in the global coordinate system, on the basis of the self-position information and the template data is provided.

Further, according to another aspect of the present disclosure, a computer-readable recording medium having a program recorded thereon, the program causing a computer to function as an information processing device including: a self-location acquisition unit configured to acquire self-position information of a mobile terminal in a global coordinate system linked to a real space; and a disposition position determination unit configured to acquire template data indicating a disposition pattern of at least one virtual object, and determine a position away from a current position of the mobile terminal indicated by the self-position information as a disposition position of a first virtual object in the global coordinate system, on the basis of the self-position information and the template data is provided.

### BRIEF DESCRIPTION OF DRAWINGS

FIG. 1 is a diagram illustrating an example of a form of a mobile terminal according to an embodiment of the present disclosure.

FIG. 2 is a diagram illustrating a functional configuration example of an HMD according to an embodiment of the present disclosure.

FIG. 3 is a diagram illustrating a configuration example of performance data.

FIG. 4 is a diagram illustrating a configuration example of formation data.

FIG. 5 is a diagram illustrating a configuration example of user data.

FIG. 6 is a diagram illustrating a configuration example of stage data.

FIG. 7 is a flowchart illustrating an example of an operation of an input stage in an information processing device according to the embodiment of the present disclosure.

FIG. 8 is a flowchart illustrating an example of an operation of an input stage in the information processing device according to the embodiment of the present disclosure.

FIG. 9 is a diagram illustrating an example of input of a body motion range radius of a user.

FIG. 10 is a diagram illustrating an example of a virtual grid.

FIG. 11 is a diagram illustrating an example of formation data.

FIG. 12 is a diagram illustrating an example of a disposition pattern.

FIG. 13 is a flowchart illustrating an example of an operation at a reproduction stage in the information processing device according to the embodiment of the present disclosure.

FIG. 14 is a flowchart illustrating an example of an operation in a reproduction stage in the information processing device according to the embodiment of the present disclosure.

FIG. 15 is a diagram illustrating an example of linear interpolation.

FIG. 16 is a diagram illustrating a display example of a motion of a virtual object being reproduced.

FIG. 17 is a diagram illustrating an example of a case in which a determination is made that there is no likelihood that members will collide.

FIG. 18 is a diagram illustrating an example of a case in which there is a likelihood that members will collide.

FIG. 19 is a diagram illustrating an example of a determination as to whether or not there is a likelihood that members will collide.

FIG. 20 is a block diagram illustrating a hardware configuration example of the information processing device.

### DESCRIPTION OF EMBODIMENTS

Hereinafter, preferred embodiments of the present disclosure will be described in detail with reference to the accompanying drawings. In the present specification and drawings, components having substantially the same functional configuration are denoted by the same reference signs, and repeated description will be omitted.

Further, in the present specification and drawings, a plurality of components having substantially the same or similar functional configuration may be distinguished by different numerals added after the same reference signs. However, when there is no particular need to distinguish between the plurality of components having substantially the same or similar functional configurations, only the same reference signs are used. Further, similar components in different embodiments may be distinguished by attaching different letter after the same reference signs. However, when there is no particular need to distinguish between similar components, only the same reference signs are used.

The description will be given in the following order.

### 0. Overview

### 1. Details of Embodiment

### 1.1. Form of Device

### 1.2. Functional Configuration Example

### 1.3. Function Details

### 2. Hardware Configuration Example

### 3. Conclusion

### 0. Overview

First, an overview of an embodiment of the present disclosure will be described. In recent years, there has been entertainment (for example, dance and drama) provided by a performance of a plurality of performers on a stage. In order to improve the quality of such a performance of the plurality of performers, it is important not only to improve the performance of each performer, but also to adjust a standing position of each performer in a state in which all the performers are present. Further, repeated practice of a motion (so-called formation) of a plurality of performers becomes important.

At the time of this formation practice, each person is required to be able to easily ascertain a correct standing position on the stage. Therefore, a technology for allowing each person to ascertain the correct standing position on the stage through an action (so-called bamiri) such as marking on the stage with a sticker or the like, for example, is generally used. However, with such technology, a situation in which it is difficult for each person to ascertain temporal change in standing position on the stage may arise. Further, with such a technology, a situation in which it is difficult to mark the standing position, for example, when a formation is complicated may arise.

Thus, various technologies are known to remedy situations that can arise at the time of formation practice. For example, a scheme for disposing a plurality of LEDs on rails laid on a ceiling of a floor and dynamically projecting standing positions of a plurality of performers onto a stage from the plurality of LEDs has been proposed.

Further, a scheme for disposing ID tags on a stage, attaching ID readers to all performers, and displaying positions of the performers in real time on the basis of a reception state of the ID tags in the ID readers has been disclosed. This makes it possible for an acting instructor to confirm the quality of the formation by viewing displayed positions of all performers.

More specifically, when these schemes are used, large-scale equipment may be required at a place (floor) at which a performance is performed. Further, when these schemes are used, it may be difficult for a performer himself or herself to visually confirm his or her standing position while practicing. Therefore, it is difficult for these schemes to be put into practical use in actual formation practice.

Further, when formation practice is performed (for example, when formation practice is performed by a group consisting of amateur performers), it may be difficult for all the performers to be present at a practice time. In this case, since other performers cannot confirm standing positions and motions of performers who have not come to the formation practice, a situation in which the efficiency of the practice is not improved and the quality of the performance is not improved may occur.

Therefore, the embodiment of the present disclosure proposes a technology for allowing input of a position (standing position) at which a performer (person) who performs a predetermined performance should be present to be easily performed in advance so that the position at which the performer should be present can be confirmed later. Hereinafter, each performer who performs a performance is also referred to as a “member” constituting a group.

More specifically, in the embodiment of the present disclosure, self-position information obtained by a wearable mobile display system (for example, a head mounted display (HMD) or a smartphone) worn by a certain member and a virtual object superimposed on the real space are used for visual observation of the standing position of each member and a temporal change in standing position during the formation practice. More specifically, first, temporal change in the standing position of each member is input as a motion of each virtual object. Thereafter, actions of each virtual object can be reproduced.

Further, in the embodiment of the present disclosure, a standing position of another member is disposed as a virtual object, or a virtual grid is set on a real space and a virtual object is disposed with reference to an intersection of the virtual grid on the basis of the self-position indicated by such self-position information and a disposition pattern. This makes it possible for a member to easily input formation data visually while actually practicing.

The overview of the embodiments of the present disclosure has been described above.

<1. Details of Embodiment>

Next, embodiments of the present disclosure will be described in detail.

(1.1. Form of Device)

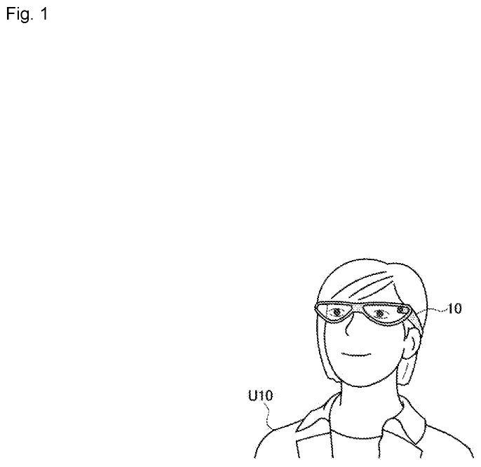

First, an example of a form of a mobile terminal according to an embodiment of the present disclosure will be described. FIG. 1 is a diagram illustrating an example of a form of a mobile terminal according to an embodiment of the present disclosure. Referring to FIG. 1, an HMD 10 is shown as an example of the mobile terminal according to the embodiment of the present disclosure. Hereinafter, it is mainly assumed that the HMD 10 is used as an example of the mobile terminal according to the embodiment of the present disclosure. However, the mobile terminal according to the embodiment of the present disclosure is not limited to the HMD 10.

For example, the mobile terminal according to the embodiment of the present disclosure may be a terminal (for example, a smartphone) other than the HMD. Alternatively, the mobile terminal according to the embodiment of the present disclosure may be configured by combining a plurality of terminals (for example, may be configured by combining an HMD and a smartphone). Referring to FIG. 1, the HMD 10 is worn on a head of a user U10 and used by the user U10.

In the embodiment of the present disclosure, it is assumed that a performance is performed by a group consisting of a plurality of members. Each of the members wears an HMD having functions equivalent to those of the HMD 10. Therefore, each of the plurality of members can be a user of the HMD. Further, as will be described below, a person (for example, an acting instructor or a manager) other than the members in the group can also wear an HMD having functions equivalent to those of the HMD 10.

The example of the form of the HMD 10 according to the embodiment of the present disclosure has been described above.

(1.2. Functional Configuration Example)

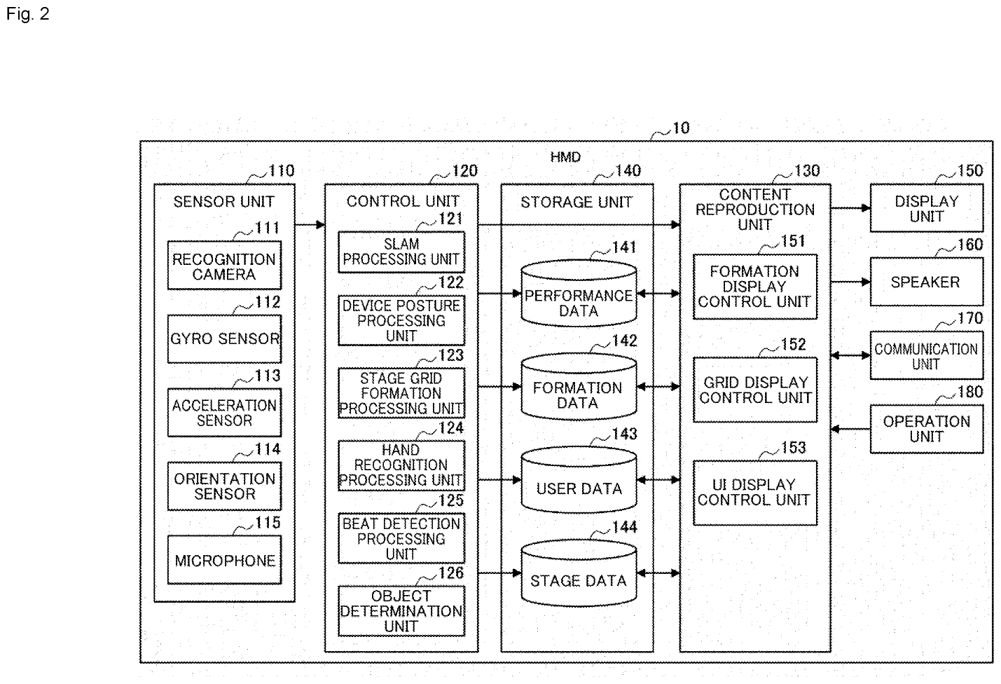

Next, a functional configuration example of the HMD 10 according to the embodiment of the present disclosure will be described. FIG. 2 is a diagram illustrating the functional configuration example of the HMD 10 according to the embodiment of the present disclosure. As illustrated in FIG. 2, the HMD 10 according to the embodiment of the present disclosure includes a sensor unit 110, a control unit 120, a content reproduction unit 130, a storage unit 140, a display unit 150, a speaker 160, a communication unit 170, and an operation unit 180.

(Sensor Unit 110)

The sensor unit 110 includes a recognition camera 111, a gyro sensor 112, an acceleration sensor 113, an orientation sensor 114, and a microphone 115 (microphone).

The recognition camera 111 images a subject (a real object) present in a real space. The recognition camera 111 is a camera (a so-called outward-facing camera) provided at a position and in an orientation allowing a surrounding environment of the user to be imaged. For example, the recognition camera 111 may be provided to be directed in a direction in which the head of the user is directed (that is, a forward side of the user) when the HMD 10 is worn on the head of the user.

The recognition camera 111 can be used to measure a distance to the subject. Therefore, the recognition camera 111 may include a monocular camera or may be a depth sensor. As the depth sensor, a stereo camera may be used, or a time of flight (TOF) sensor may be used.

The gyro sensor 112 (an angular velocity sensor) corresponds to an example of a motion sensor, and detects an angular velocity of the head of the user (that is, an angular velocity of the HMD 10). The acceleration sensor 113 corresponds to an example of the motion sensor, and detects an acceleration of the head of the user (that is, acceleration of the HMD 10). The orientation sensor 114 corresponds to an example of the motion sensor, and detects the orientation of the head of the user (that is, the orientation of the HMD 10). The microphone 115 detects sound in surroundings of the user.

(Control Unit 120)

The control unit 120 may be configured of, for example, one or more central processing units (CPUs). When the control unit 120 is configured of a processing device such as a CPU, the processing device may be configured of an electronic circuit. The control unit 120 can be realized by such a processing device executing a program.

The control unit 120 includes a simultaneous localization and mapping (SLAM) processing unit 121, a device posture processing unit 122, a stage grid formation processing unit 123, a hand recognition processing unit 124, a beat detection processing unit 125, and an object determination unit 126.

(SLAM Processing Unit 121)

The SLAM processing unit 121 performs estimation of a position and posture of the SLAM processing unit 121 in a global coordinate system linked to the real space and creation of a surrounding environment map in parallel on the basis of a technique called SLAM. Accordingly, information indicating the position (self-position information) of the SLAM processing unit 121, information indicating the posture (self-posture information) of the SLAM processing unit 121, and the surrounding environment map are obtained.

More specifically, the SLAM processing unit 121 sequentially estimates a three-dimensional shape of a captured scene (or subject) on the basis of a moving image obtained by the recognition camera 111. Along with this, the SLAM processing unit 121 estimates information indicating relative change in a position and posture of the recognition camera 111 (that is, the HMD 10) on the basis of detection results of various sensors such as motion sensors (for example, the gyro sensor 112, the acceleration sensor 113, and the orientation sensor 114), as the self-position information and self-posture information. The SLAM processing unit 121 can perform the creation of the surrounding environment map and the estimation of the self-position and posture in the environment in parallel by associating the three-dimensional shape with the self-position information and self-posture information.

In the embodiment of the present disclosure, it is mainly assumed that the SLAM processing unit 121 recognizes a predetermined surface (for example, a floor surface) present in the real space. In particular, in the embodiment of the present disclosure, it is assumed that the SLAM processing unit 121 recognizes that a stage surface on which the performances are performed by a plurality of members constituting a group is an example of the predetermined surface (the floor surface). However, the surface recognized by the SLAM processing unit 121 is not particularly limited as long as the surface is a place at which the performance can be performed.

(Device Posture Processing Unit 122)

The device posture processing unit 122 estimates change in orientation of the motion sensor (that is, the HMD 10) on the basis of the detection results of various sensors such as the motion sensor (for example, the gyro sensor 112, the acceleration sensor 113, and the orientation sensor 114). Further, the device posture processing unit 122 performs estimation of a direction of gravity on the basis of the acceleration detected by the acceleration sensor 113. The change in orientation of the HMD 10 and the direction of gravity estimated by the device posture processing unit 122 may be used for an input of an operation by the user.

(Stage Grid Formation Processing Unit 123)

The stage grid formation processing unit 123 can function as a grid setting unit that disposes (sets) a virtual grid in the real space on the basis of the self-position information obtained by the SLAM processing unit 121 when the motion of the virtual object is input. More specifically, when the SLAM processing unit 121 recognizes the stage surface as an example of the predetermined surface (for example, the floor surface) present in the real space when the motion of the virtual object is input, the stage grid formation processing unit 123 determines a disposition position and orientation of the virtual grid in the global coordinate system in the real space on the basis of a recognition result of the stage surface, and the self-position information. The virtual grid will be described in detail below. Hereinafter, determining the position and orientation of the virtual grid is also referred to as “grid formation”.

(Hand Recognition Processing Unit 124)

The hand recognition processing unit 124 performs measurement of a predetermined length regarding the body of the user. In the embodiment of the present disclosure, a case in which the hand recognition processing unit 124 recognizes a hand of the user (for example, a palm) from the captured image of the recognition camera 111, and measures a distance from the recognition camera 111 to the hand of the user (that is, a distance from the head to the hand of the user), as an example of the predetermined length regarding the body of the user is mainly assumed. However, the predetermined length regarding the body of the user is not limited to such an example. For example, the predetermined length regarding the body of the user may be the distance between two other points on the body of the user.

(Beat Detection Processing Unit 125)

The beat detection processing unit 125 detects a beat of the music data on the basis of reproduced sound of the music data detected by the microphone 115. In the embodiment of the present disclosure, a case in which a predetermined performance (such as dance) is performed according to the reproduction of a music song is mainly assumed. Further, in the embodiment of the present disclosure, a case in which reproduction of the music song is performed in a system external to the HMD 10 (for example, an acoustic system as a stage equipment) is mainly assumed. That is, when the sound of the music song reproduced by the system external to the HMD 10 is detected by the microphone 115, the beat detection processing unit 125 detects a beat from a waveform of the sound. However, the beat may be input by an operation of the user.

(Object Determination Unit 126)

The object determination unit 126 determines various types of information on a virtual object disposed on the global coordinate system linked to the real space. As an example, the object determination unit 126 functions as a disposition position determination unit that determines a position (disposition position) in the global coordinate system at which the virtual object is disposed. Further, as another example, the object determination unit 126 functions as a size determination processing unit that determines a size of the virtual object. The determination of the position and the size of the virtual object will be described in detail below. Further, the object determination unit 126 associates position information of the virtual object with time count information indicating the time count when the motion of the virtual object is input.

(Content Reproduction Unit 130)

The content reproduction unit 130 may be configured of one or more central processing units (CPUs). When the content reproduction unit 130 is configured of a processing device such as a CPU, such a processing device may be configured of an electronic circuit. The content reproduction unit 130 can be realized by such a processing device executing a program. The processing device constituting the content reproduction unit 130 and the processing device constituting the control unit 120 may be the same processing device or may be different processing devices.

The content reproduction unit 130 includes a formation display control unit 151, a grid display control unit 152, and a user interface (UI) display control unit 153.

(Formation Display Control Unit 151)

The formation display control unit 151 controls the display unit 150 so that the virtual object is disposed in the global coordinate system linked to the real space at the time of reproduction of the motion of the virtual object. As described above, the time count information is associated with the position information of the virtual object. Therefore, when reproduction of the motion of the virtual object starts, the formation display control unit 151 causes the time count to progress as time elapses, and controls the display unit 150 so that the virtual object is disposed at the position of the virtual object associated with the time count information indicating the time count.

(Grid Display Control Unit 152)

The grid display control unit 152 can function as a grid setting unit that disposes a virtual grid in the real space on the basis of the self-position information obtained by the SLAM processing unit 121 when the motion of the virtual object is reproduced. More specifically, when the SLAM processing unit 121 recognizes that the stage surface is an example of the predetermined surface (for example, the floor surface) present in the real space when the motion of the virtual object is reproduced, the grid display control unit 152 controls the display unit 150 so that a virtual grid is disposed in the global coordinate system in the real space, on the basis of the recognition result of the stage surface and the self-position information.

(UI Display Control Unit 153)

The UI display control unit 153 controls the display unit 150 so that the display unit 150 displays various types of information other than the information disposed on the global coordinate system linked to the real space. As an example, the UI display control unit 153 controls the display unit 150 so that the display unit 150 displays preset various types of setting information (for example, a performance name and a music song name). Further, the UI display control unit 153 controls the display unit 150 so that the time count information associated with the position information of the virtual object is displayed when the motion of the virtual object is input and when the motion of the virtual object is reproduced.

(Storage Unit 140)

The storage unit 140 is a recording medium that includes a memory, and that stores programs executed by the control unit 120, stores programs executed by programs executed by the content reproduction unit 130, or stores data (such as various pieces of databases) required for execution of the programs. Further, the storage unit 140 temporarily stores data for calculation in the control unit 120 and the content reproduction unit 130. The storage unit 140 includes a magnetic storage device, a semiconductor storage device, an optical storage device, a magneto-optical storage device, or the like.

The storage unit 140 stores performance data 141, formation data 142, user data 143, and the stage data 144 as an example of a database. These databases may not be stored in the storage unit 140 inside the HMD 10. For example, some or all of these databases may be stored in a device (for example, a server) external to the HMD 10. In this case, the HMD 10 may receive data from the external device through the communication unit 170. Hereinafter, configuration examples of these databases will be described.

(Performance Data 141)

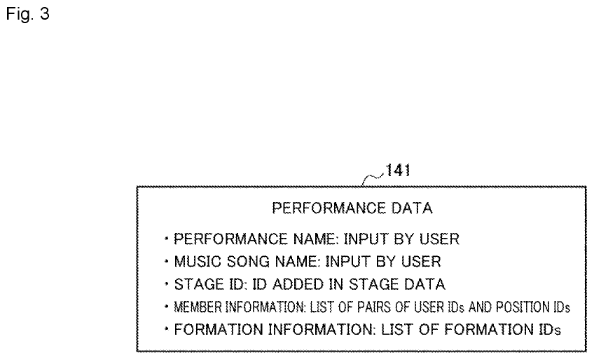

FIG. 3 is a diagram illustrating a configuration example of the performance data 141. The performance data 141 is data for managing the entire performance, and for example, as illustrated in FIG. 3, the performance data 141 is information in which the performance name, the music song name, a stage ID, member information, formation information, and the like are associated with each other.

The performance name is a name of the performance performed by the group and can be input by the user, for example. The song name is a name of a music song reproduced with the performance, and may be input by the user, for example. The stage ID is an ID similar to the ID added in the stage data. The member information is a list of pairs of a user ID that is an ID for identifying the user and a position ID for identifying a position (for example, a center) in the entire group of users. The formation information is a list of formation IDs.

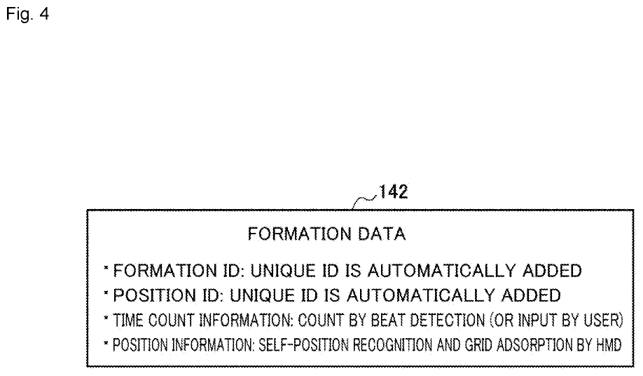

FIG. 4 is a diagram illustrating a configuration example of the formation data 142. The formation data 142 is data regarding formation, and is information in which the formation ID, the position ID, the time count information, the position information, and the like are associated with each other, for example, as illustrated in FIG. 4.

The formation ID is an ID for uniquely identifying a formation, and can be automatically added. The position ID is an ID for uniquely identifying the position and can be automatically added. The time count information is an elapsed time (time count) with reference to the start of reproduction of the motion of the virtual object and can be obtained by beat detection. Alternatively, the time count information may be input by the user. The position information is information indicating a standing position of each user linked to the time count information, and can be acquired by the self-position information and grid adsorption. The grid adsorption will be described below in detail.

(User Data 143)

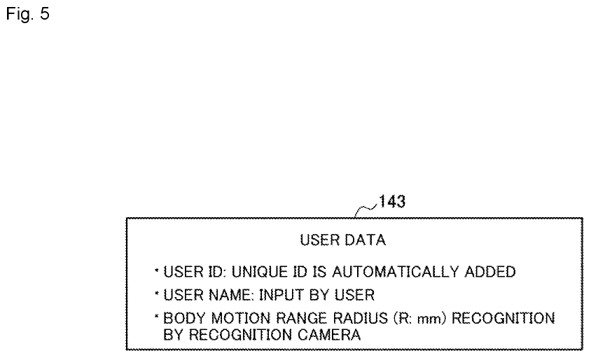

FIG. 5 is a diagram illustrating a configuration example of the user data 143. The user data 143 is data for managing information linked to each user for each user and is, for example, information in which the user ID, the user name, body motion range radius, and the like are associated with each other, as illustrated in FIG. 5.

The user ID is an ID for uniquely identifying a user and can be automatically added. The user name is a name of the user and can be input by the user himself or herself. The body motion range radius is information corresponding to an example of the predetermined length regarding the body of the user, and can be recognized on the basis of the captured image captured by the recognition camera 111. For example, a unit of the body motion range radius may be expressed in millimeters (mm).

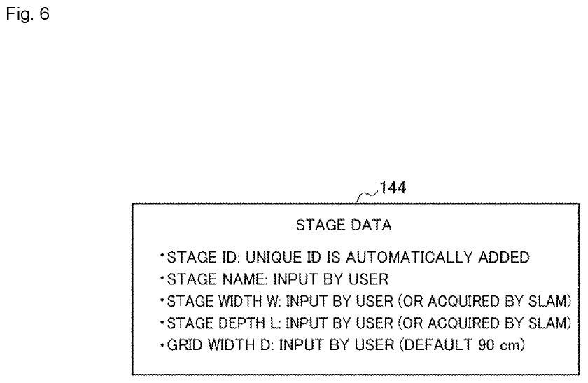

FIG. 6 is a diagram illustrating a configuration example of the stage data 144. The stage data 144 is data regarding a stage, and is information in which, for example, the stage ID, a stage name, a stage width W, a stage depth L, and a grid width D are associated with each other, as illustrated in FIG. 6.

The stage ID is an ID for uniquely identifying the stage, and can be automatically added. The stage name is a name of the stage and can be input by the user. The stage width W is a length in a left-right direction of the stage as viewed from the audience side, and can be input by the user. Alternatively, the stage width W may be automatically acquired by the SLAM processing unit 121. The stage depth L is a length in a depth direction of the stage viewed from the audience side and can be input by the user. Alternatively, the stage depth L may be automatically acquired by the SLAM processing unit 121. The grid width D indicates an interval of the virtual grid (for example, a default value may be 90 cm) and may be input by the user.

(Relationship Between Each Piece of Data and Global Coordinate System)

A relationship between each piece of data and the global coordinate system is summarized as follows.

The stage data 144 is information on the virtual grid (object) that is disposed according to the actual stage in the global coordinate system linked to the real space. Such a virtual grid is independent of a camera coordinate system linked to a self-position and posture of the user. Therefore, the virtual grid does not change with the self-position and posture of the user. Further, the virtual grid does not change over time. A reference point of the virtual grid is generally an endpoint on the audience side at a center of the stage.

The formation data 142 is information on the virtual object disposed according to the actual stage in the global coordinate system linked to the real space, like the stage data. Such a virtual object is independent of the camera coordinate system linked to the self-position and posture of the user. Therefore, the virtual object does not change with the self-position and posture of the user. A disposition position of the virtual object is required to change over time, unlike the virtual grid. Therefore, the position information of the virtual object and the time count information, which is time information, are linked. The reference point of the position information of the virtual object is the end point on the audience side at the center of the stage, like the stage data, and a reference of the time count information is the time of the start of reproduction of the music song.

The user data 143 includes the body motion range radius of the user, and the size of the virtual object (for example, when the virtual object has a cylindrical shape, the body motion range radius corresponds to a radius of the cylinder). A criterion of the body motion range is a self-position input by the user. Therefore, when the user wearing the HMD 10 moves according to the input, the virtual object appears to track a movement of the user. Similarly, when another user also moves according to the input, a body motion range of the other body appears to track a movement of the other user.

The performance data 141 is management data for linking and managing the stage data 144, the formation data 142, and the user data 143. Therefore, the performance data 141 does not have a coordinate system serving as a reference. Next, referring back to FIG. 2, the description continues.

(Display Unit 150)

The display unit 150 is an example of an output device that outputs various types of information under the control of the content reproduction unit 130. The display unit 150 is configured of a display. In the embodiment of the present disclosure, it is mainly assumed that the display unit 150 is configured of a transmissive display capable of visually recognizing an image in a real space. However, the display unit 150 may be an optical see-through display or may be a video see-through display. Alternatively, the display unit 150 may be a non-transmissive display that presents an image in a virtual space having a three-dimensional structure corresponding to the real space, instead of the image in the real space.

A transmissive display is mainly used for augmented reality (AR), and a non-transmissive display is mainly used for virtual reality (VR). The display unit 150 may also include an X reality (XR) display that is used for both AR and VR applications. For example, the display unit 150 displays a virtual object, a virtual grid, and the like in AR, and displays time count information and the like in UI.

(Speaker 160)

The speaker 160 is an example of an output device that outputs various types of information under the control of the content reproduction unit 130. In the embodiment of the present disclosure, it is mainly assumed that the display unit 150 outputs various types of information, but the speaker 160 may output various types of information, instead of the display unit 150 or together with the display unit 150. In this case, the speaker 160 outputs various types of information as audio under the control of the content reproduction unit 130.

(Communication Unit 170)

The communication unit 170 is configured of a communication interface. For example, the communication unit 170 communicates with a server (not illustrated) or communicates with an HMD of another user.

(Operation Unit 180)

The operation unit 180 has a function of receiving an operation input by a user. For example, the operation unit 180 may be configured of an input device such as a touch panel or buttons. For example, the operation unit 180 receives an operation touched by the user as a determination operation. Further, selection of an item according to a posture of the HMD 10 obtained by the device posture processing unit 122 may be executed by the determination operation received by the operation unit 180.

The functional configuration example of the HMD 10 according to the embodiment of the present disclosure has been described above.

(1.3. Function Details)

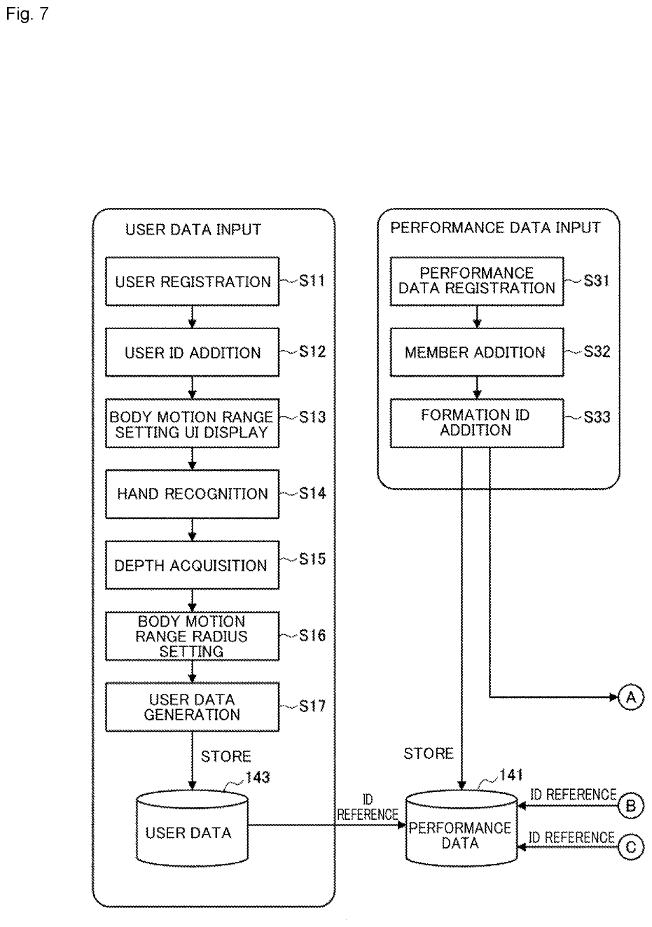

Subsequently, details of the functions of the HMD 10 according to the embodiment of the present disclosure will be described with reference to FIGS. 7 to 12 (also with appropriate reference to FIGS. 1 to 6). An operation of the HMD 10 according to the embodiment of the present disclosure is roughly divided into an input stage and a reproduction stage. In the input stage, the user data 143, the stage data 144, the performance data 141 and the formation data 142 are input. The input of the formation data 142 includes the input of a motion of the virtual object. On the other hand, in the reproduction stage, the motion of the virtual object is reproduced according to the formation data 142.

(Input Stage)

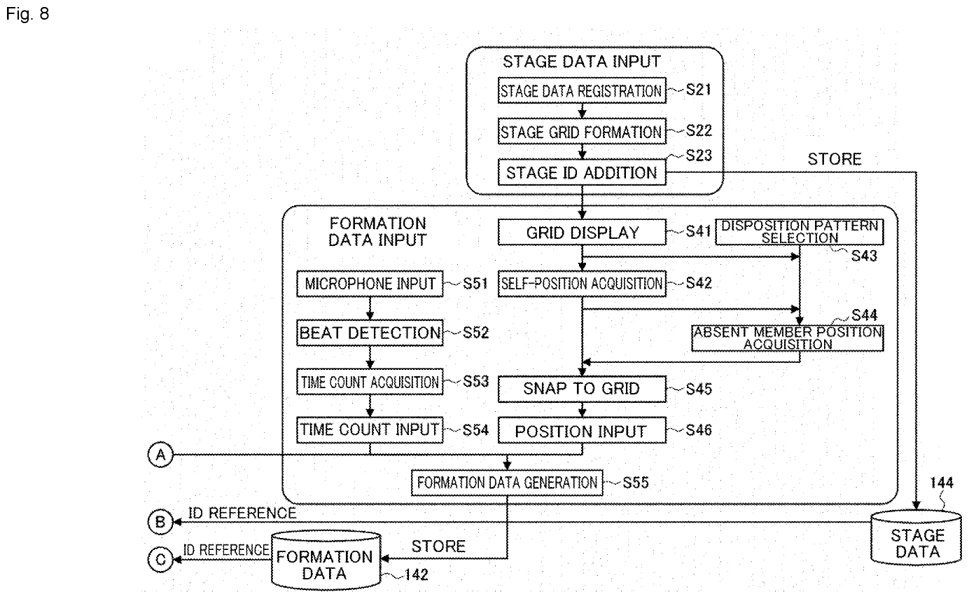

First, an example of an operation of the input stage in the HMD 10 according to the embodiment of the present disclosure will be described. FIGS. 7 and 8 are flowcharts illustrating an example of an operation of the input stage in the HMD 10 according to an embodiment of the present disclosure.

(User Data Input)

First, a user data input operation will be described. The user inputs his or her own name (user name) via the operation unit 180 before formation practice (S11). The user ID is automatically added to the user name (S12). A case in which the user name is input by the user himself or herself is mainly assumed, but names of all users may be input by one user or another person (for example, an acting instructor or a manager).

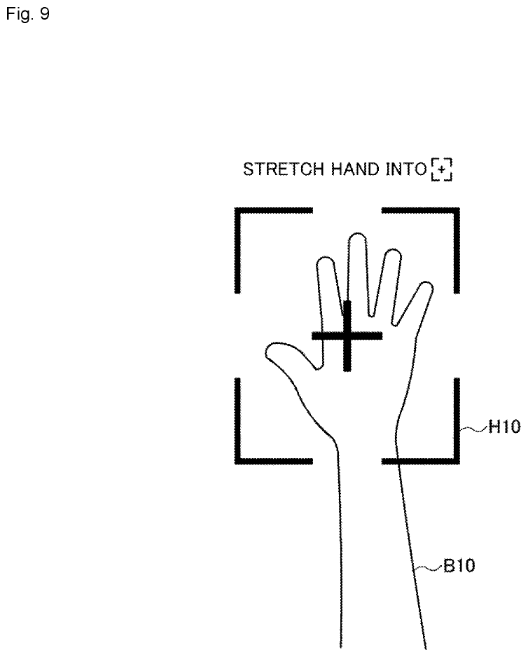

Subsequently, the body motion range radius of the user is input. FIG. 9 is a diagram illustrating an example of input of the body motion range radius of the user. As illustrated in FIG. 9, the UI display control unit 153 controls the display unit 150 so that a UI (a body motion range setting UI) requesting the user to extend a position of a hand is displayed (S13). More specifically, the body motion range setting UI may be an object 1110 having a predetermined shape, which is displayed at a position of the hand captured by the recognition camera 111, when a user B10 having a normal body size extends his or her hand in a horizontal direction.

The hand recognition processing unit 124 recognizes the hand of the user (for example, a palm) from an image captured by the recognition camera 111 (S14), and measures the distance from the recognition camera 111 to the hand of the user (that is, the distance from the head to the hand of the user) as an example of the predetermined length regarding the body of the user (S15). The distance measured in this manner is set as the body motion range radius (that is, the size of the virtual object corresponding to the user) by the object determination unit 126 (a size determination processing unit) (S16). This makes it possible for an individual difference in the body motion range to be reflected in the size of the virtual object.

As described above, the recognition camera 111 may include a monocular camera or may include a depth sensor. A stereo camera may be used as the depth sensor, or a TOF sensor may be used.

When the recognition camera 111 includes a monocular camera, feature points are extracted from a luminance difference, or the like in an image captured by the monocular camera, a hand shape is recognized on the basis of the extracted feature points, and the distance from the head to the hand of the user is estimated from a size of the hand. That is, since passive recognition can be performed by the monocular camera, a recognition scheme using the monocular camera is a scheme suitable for a mobile terminal. On the other hand, when the recognition camera 111 includes a depth sensor, the distance from the head to the hand of the user can be measured with high accuracy.

Information in which the user ID, the user name, and the body motion range radius are associated with each other is generated as user data for one person (S17). The generated user data is recorded in the user data 143 of the storage unit 140.

(Stage Data Input)

Next, an operation of the stage data input will be described. A representative of a plurality of users constituting a group inputs, via the operation unit 180, the stage name, the stage width W, the stage depth L, and an orientation of the stage (for example, which direction is a direction of the audience seat side) before formation practice (S21). However, as described above, the stage width W and stage depth L may be automatically acquired by the SLAM processing unit 121. These pieces of information can be used for a setting of a virtual grid. These pieces of information may be input once for each stage, and may be input by a person (for example, a performance instructor or a manager) other than the representative.

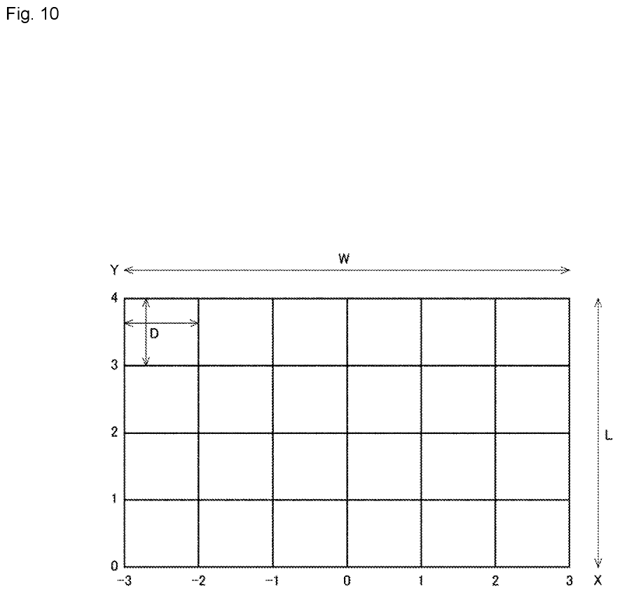

FIG. 10 is a diagram illustrating an example of the virtual grid. As illustrated in FIG. 10, the virtual grid includes a plurality of straight lines set at a predetermined interval (the grid width D) in a depth direction of the stage (as an example of a first direction) and in the left-right direction of the stage viewed from the audience side (as an example of a second direction). Further, the stage width W and the stage depth L are illustrated in FIG. 10. The stage width W and the stage depth L are actual dimensions. The first direction and the second direction may not be orthogonal. Further, the grid width D may be different in the depth direction and the left-right direction of the stage.

The predetermined surface (for example, the floor surface) present in the real space is recognized as the stage surface by the SLAM processing unit 121. The stage grid formation processing unit 123 determines the position and orientation of the virtual grid disposed in the real space on the basis of the recognition result of the stage surface. More specifically, the stage grid formation processing unit 123 performs the determination of the position and orientation of the virtual grid (grid formation) so that the position and orientation of the stage surface recognized by the SLAM processing unit 121 and the position of the stage (defined by the stage width W and the stage depth L) and the input orientation of the stage match (S22). The stage ID is automatically added to the stage name (S23). The stage data generated in this manner is recorded in the stage data 144 of the storage unit 140.

(Performance Data Input)

Next, a performance data input operation will be described. The representative of the plurality of users constituting the group inputs a performance name, a music song name that is used in the performance, a name of a stage (linked to a stage ID) on which the performance is performed, and the number of users participating in the performance via the operation unit 180 before formation practice (S31). The performance name, the song name, and the stage ID (corresponding to the stage name) are recorded in the performance name, the song name, and the stage ID of the performance data 141. Further, the number of pieces of member information corresponding to the number of participating users is secured in the performance data 141. These pieces of information may also be input once for each performance, and may be input by a person (for example, a performance instructor or a manager) other than the representative.

A user participating in the performance performs an operation of selecting the performance data via the operation unit 180 and inputs a user name of the user and a position name via the operation unit 180. In this case, the position ID corresponding to the position name is automatically assigned, and a combination of the user ID (corresponding to the user name) and the position ID is recorded in the member information of the performance data 141 (S32).

Further, the representative of the plurality of users constituting the group performs an operation of inputting one or more formation names that are used in the performance via the operation unit 180. In this case, information (the formation ID) for identifying each of the one or more formation names input by the representative is automatically assigned (S33), and recorded as the list of formation IDs (the formation information) in the formation information of the performance data 141. The formation name may also be input once for each performance, and may be input by a person (for example, a performance instructor or a manager) other than the representative.

(Formation Data Input)

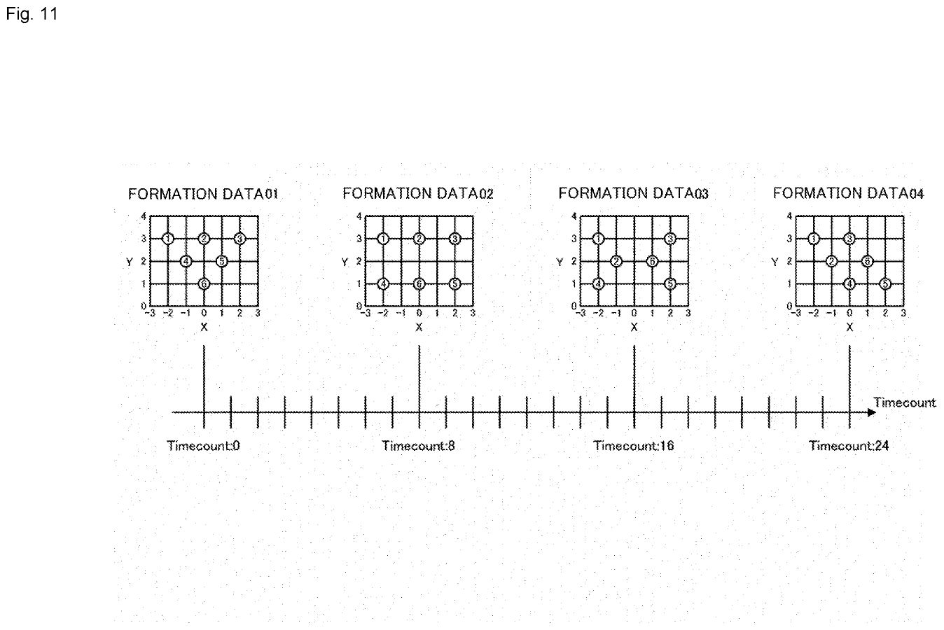

Next, an operation of formation data input will be described. FIG. 11 is a diagram illustrating an example of the formation data. In the example illustrated in FIG. 11, it is assumed that the number of participating users is 6, and the position of each user is indicated as “1” to “6” on XY coordinates formed by the virtual grid. Here, it is assumed that positions of six users change as the time count progresses. That is, it is assumed that a correspondence relationship between the time count information and the position information of each user changes as illustrated in FIG. 11 as an example.

The user participating in the performance wears the HMD 10 and selects the performance data at the time of formation practice. In this case, in the HMD 10 of the user, the grid display control unit 152 controls the display unit 150 so that the display unit 150 displays the virtual grid according to the position and orientation of the virtual grid determined by the stage grid formation processing unit 123 (S41).

As described above, here, it is assumed that the performance is performed according to the reproduction of a music song. That is, it is assumed that the time count information is associated with the music data. A case in which the reproduction of the music is performed in an external system is assumed. That is, when a sound of a piece of music reproduced by the external system is detected by the microphone 115 (S51), the beat detection processing unit 125 detects a beat from the waveform of the sound (S52). However, the beat may be input by operation of the user.

The object determination unit 126 causes the time count to progress according to the beat detected by the beat detection processing unit 125. This makes it possible to perform formation switching according to the music song. This also makes it possible to cope with sudden change in reproduction speed of the music song, frequent pauses in the reproduction of the music song, and the like. The user moves to the position at which the user should be present according to the reproduction of the music song (that is, according to the progress of the time count).

When the user wants to record the position at which the user should be present, the user inputs a predetermined determination operation via the operation unit 180. A recording operation is not limited. For example, when the operation unit 180 is configured of a touch panel, the determination operation may be a touch operation on the touch panel. Alternatively, when the operation unit 180 is configured of buttons, the determination operation may be an operation of pressing the button. Alternatively, the determination operation may be any gesture operation. When the determination operation is input, the object determination unit 126 acquires the self-position information estimated by the SLAM processing unit 121 (S42).

Here, for some reason, there may be a user who does not directly input a position at which the user should be present in the formation. That is, it is conceivable that another user inputs a position at which a certain user should be present instead. For example, it is conceivable that a user who is attending the practice instead inputs a position at which a user who is not attending the practice should be present. Hereinafter, a user who asks another user to input a position at which the user should be present is also referred to as an “absent member”. Further, the other user is also referred to as an “attending member”.

For example, when template data indicating the disposition pattern of an absent member (that is, the virtual object corresponding to the absent member) is prepared in advance, it becomes possible to easily input a position at which the absent member should be present, on the basis of the template data.

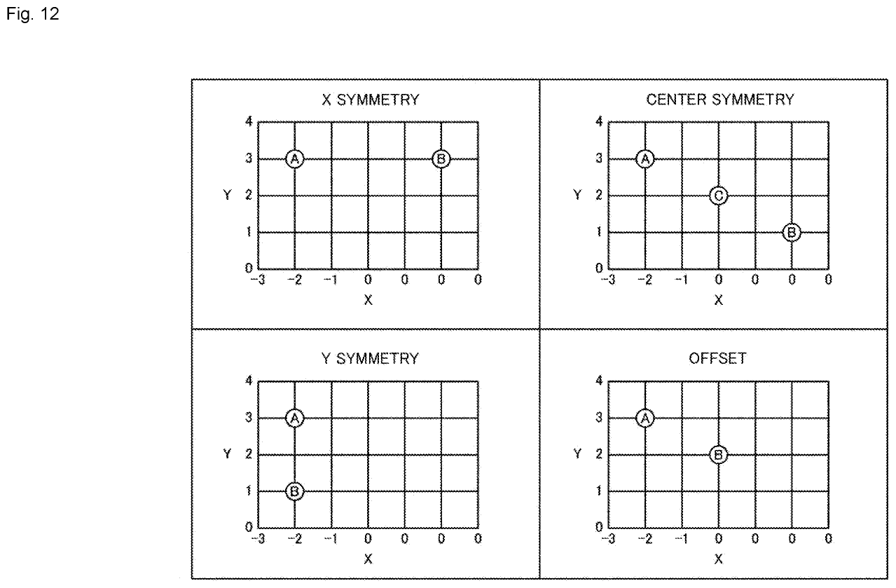

FIG. 12 is a diagram illustrating an example of the disposition pattern. In FIG. 12, examples of the disposition pattern may include “X symmetry”, “center symmetry”, “Y symmetry”, and “offset”. However, the disposition pattern is not limited to the example given in FIG. 12. In the example illustrated in FIG. 12, an example of the positional relationship between members is shown on the XY coordinates formed by the virtual grid. Here, it is assumed that “A” is the attending member and “B” is the absent member.

The “X symmetry” is a positional relationship in which a position of an absent member “B” is a position line-symmetrical to a position of an attending member “A” with respect to an X=0 axis. That is, the position of the absent member “B” is (−XA, YA) with respect to a position (XA, YA) of the attending member “A”.

The “center symmetry” is a positional relationship in which the position of the absent member “B” is a position point-symmetrical to the position of the attending member “A” with respect to the reference point. The reference point may be determined in advance or may be designated by the attending member. That is, when the position of the reference point is (XC, YC), the position of the absent member “B” is (2×XA−XC, 2×YC−YA) with respect to the position (XA, YA) of the attending member “A”.

The “Y symmetry” is a positional relationship in which the position of the absent member “B” is a position line-symmetrical to the position of the attending member “A” with respect to a predetermined Y axis. That is, when the Y axis is Y=YS, the position of the absent member “B” is (XA, 2×YS−YA) with respect to the position (XA, YA) of the attending member “A”.

The “Offset” is a positional relationship in which the position of the absent member “B” is a position obtained by translating the position of the attending member “A” by a reference displacement amount. The reference displacement amount may be determined in advance or may be designated by the attending member. That is, when the reference displacement amount is (X0, Y0)=(2, −1), the position of the absent member “B” is (XA+2, YA−1) with respect to the position (XA, YA) of attending member “A”.

Referring back to FIG. 8, the description continues. The template data indicating the disposition pattern as illustrated in FIG. 12 is stored in advance by the storage unit 140. Therefore, the object determination unit 126 acquires the template data, and determines the disposition position of the virtual object (a first virtual object) corresponding to the absent member in the global coordinate system on the basis of the self-position information of the HMD 10 of the attending member and the template data. This makes it possible to easily perform input of the position at which the absent member should be present in advance in order to confirm the position at which the absent member should be present later.

For example, the object determination unit 126 determines a position away from the current position of the HMD 10 indicated by the self-position information of the HMD 10 of the attending member to be the disposition position of the virtual object (the first virtual object) corresponding to the absent member. Although only one piece of template data may be prepared, it is assumed here that a plurality of pieces of template data are prepared, and the attending member inputs an operation for selecting desired template data (desired disposition pattern) from the plurality of pieces of template data via the operation unit 180 (S43).

The object determination unit 126 determines the disposition position of the virtual object (a second virtual object) corresponding to the attending member himself or herself in the global coordinate system on the basis of the current position of the HMD 10 indicated by the self-position information. In this case, it is preferable for the object determination unit 126 to determine the disposition position of the virtual object (the second virtual object) corresponding to the attending member himself or herself in association with the intersection of the virtual grid on the basis of the self-position information. This can simplify the disposition position of the virtual object (the second virtual object).

In particular, it is preferable for the object determination unit 126 to adopt a scheme (so-called grid adsorption) for determining an intersection of the virtual grid closest to the current position of the HMD 10 indicated by the self-position information as the disposition position of the virtual object corresponding to the attending member himself or herself. Accordingly, even when a position at which the determination operation has been input deviates from the intersection of the virtual grid, the position corresponding to the attending member is automatically corrected to the intersection of the virtual grid, and thus, the position information of the virtual object corresponding to the attending member can be easily input.

Further, the object determination unit 126 acquires the template data selected from the plurality of pieces of template data, and determines the disposition position of the virtual object (the first virtual object) corresponding to the absent member in the global coordinate system on the basis of the self-position information of the HMD 10 of the attending member and the selected template data (S44). In this case, the object determination unit 126 preferably determines the disposition position of the virtual object (the first virtual object) corresponding to the absent member in association with the intersection of the virtual grid on the basis of the self-position information. This can simplify the disposition position of the virtual object (the first virtual object) corresponding to the absent member.

In particular, it is preferable for the object determination unit 126 to adopt a scheme for determining the intersection of the virtual grid closest to the point determined according to the current position of the HMD 10 indicated by the self-position information and the template data to be the disposition position of the virtual object corresponding to the absent member (so-called grid adsorption). Accordingly, even when a position at which the determination operation has been input deviates from the intersection of the virtual grid, the position corresponding to the absent member is automatically corrected to the intersection of the virtual grid, and thus, the position information of the virtual object corresponding to the absent member can be easily input.

An order of conversion based on the template data and the grid adsorption (snap to the grid S45) does not matter. That is, the grid adsorption may be first performed on the position at which the attending member has input the determination operation, and then the conversion based on the disposition pattern may be performed. Alternatively, the position at which the attending member has input the determination operation may first be converted on the basis of the disposition pattern, and then the grid adsorption may be performed later.

The object determination unit 126 acquires the information on the time count that has progressed at a speed according to the beat detected by the beat detection processing unit 125 (S53), and inputs the time count information to the formation data (S54). Further, the object determination unit 126 inputs the position information of the virtual object corresponding to the attending member and the position information of the virtual object corresponding to the absent member to the formation data together with the position ID as respective position information (S46).

Further, the object determination unit 126 generates formation data by adding the formation ID obtained from the formation information included in the performance data selected by the attending member to the time count information, the position ID, and the position information (S55). The object determination unit 126 records the generated formation data in the storage unit 140 (that is, records a correspondence relationship among the formation ID, the position ID, the time count information, and the position information in the storage unit 140).

The time count information associated with the position information of the virtual object may be appropriately specified by the attending member. This makes it possible to easily perform an input of the position information of the virtual object.

For example, the time count may be changeable according to a predetermined change operation input via the operation unit 180 by the attending member. For example, the change operation may be performed by an input of the determination operation in a state in which a time count after changing is selected according to the posture of the HMD 10. Alternatively, the time count may be stopped in response to a predetermined stop operation input via the operation unit 180 by the attending member. For example, the stop operation may be performed by a determination operation in a state in which stop is selected according to the orientation of the HMD 10.

When the time count information (first time count information indicating a first time) is specified by the attending member in this manner, the object determination unit 126 acquires the specified time count information. The object determination unit 126 records, in the storage unit 140, a correspondence relationship between a disposition position (first disposition position) of the virtual object corresponding to the absent member and the time count information specified by the attending member, which is determined on the basis of the disposition pattern (a first disposition pattern) indicated by the template data (first template data) selected by the attending member and the current position.

In this case, the object determination unit 126 may also record, in the storage unit 140, a correspondence relationship between the disposition position of the virtual object corresponding to the attending member specified on the basis of the current position and the time count information specified by the attending member. Such input of the position of the virtual object corresponding to each of the attending member and the absent member is repeatedly performed, and as an example, when the motion input until the end of the music song is completed, an input of the motion of the virtual object corresponding to each of the attending member and the absent member (input of formation data) ends.

Although an example in which the input of the motion of the virtual object corresponding to each of the attending member and the absent member is performed at the same time has been described above, there may be an attending member who inputs only a motion of a virtual object corresponding to the attending member. In any case, as the input of the motion of the virtual object by the attending member progresses, the input of the motion of the virtual object for all users participating in the performance is eventually completed.

The example of the operation of the input stage of the HMD 10 according to the embodiment of the present disclosure has been described above.

(Reproduction Stage)

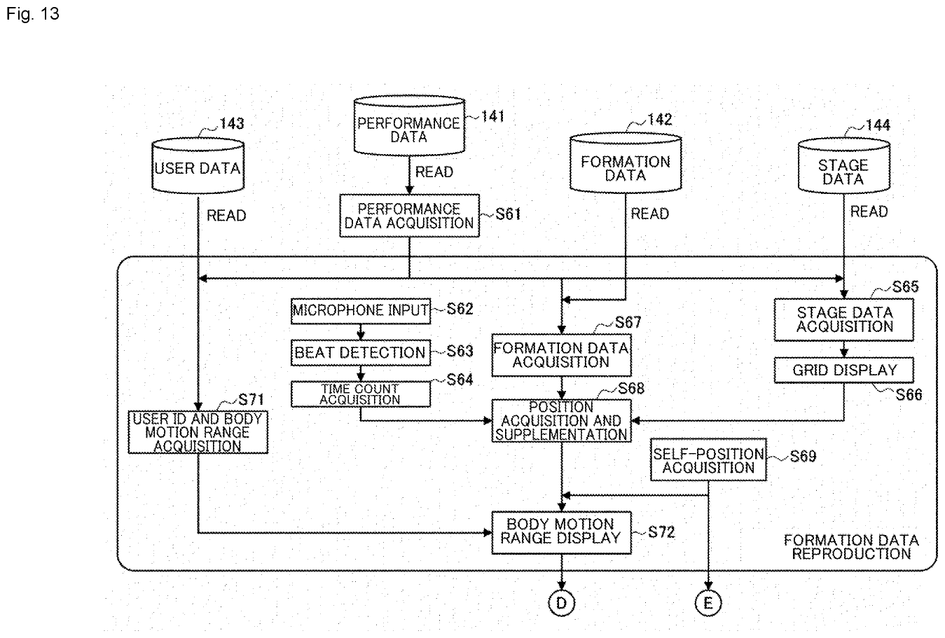

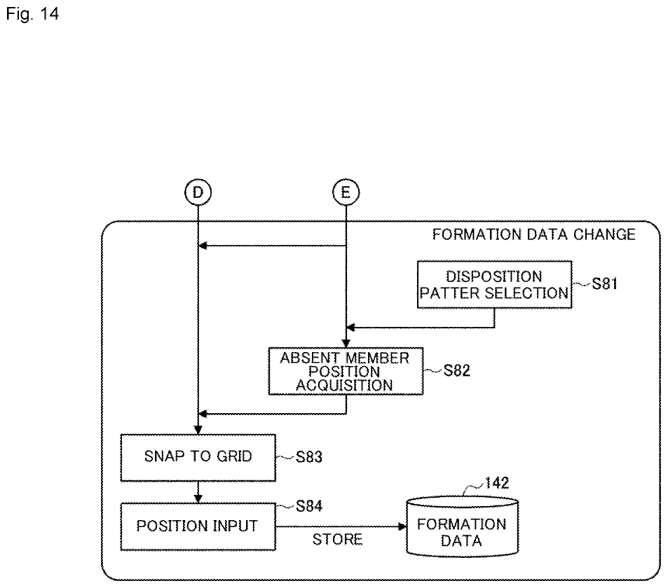

Next, an example of an operation in the reproduction stage of the HMD 10 according to the embodiment of the present disclosure will be described. FIGS. 13 and 14 are flowcharts illustrating an example of an operation of the reproduction stage in the HMD 10 according to an embodiment of the present disclosure.

When the user wears the HMD 10 at the time of formation practice, the performance data 141 is read. The UI display control unit 153 acquires the read performance data 141 (S61) and controls the display unit 150 to display the performance data 141. The user selects desired performance data from the read performance data 141.

When the performance data is selected by the user, the user data is read on the basis of the user ID of the member information included in the performance data selected by the user. Accordingly, the user ID and the body motion range radius are acquired (S71). Further, the formation data is read on the basis of the formation information included in the performance data selected by the user. Accordingly, the formation data is acquired (S67). Further, the stage data is read on the basis of the stage ID included in the performance data selected by the user. Thus, the stage data is acquired (S65).

In this case, in the HMD 10 of the user, the grid display control unit 153 controls the display unit 150 so that the virtual grid is displayed according to the position and orientation of the virtual grid determined by the stage grid formation processing unit 123 (S66).

In the reproduction stage, it is also assumed that the performance is performed according to the reproduction of the music song, as in the input stage. That is, it is assumed that the time count information is associated with the music data. A case in which the reproduction of the music song is performed in an external system is assumed. That is, when a sound of the music song reproduced by the external system is detected by the microphone 115 (S62), the beat detection processing unit 125 detects a beat from the waveform of the sound (S63). However, the beat may be input by operation of the user.

The object determination unit 126 causes the time count to progress according to the beat detected by the beat detection processing unit 125. Accordingly, the time count information indicating the time count is acquired (S64). The formation display control unit 151 controls the display unit 150 so that the virtual object is disposed on the basis of the position information associated with the time count information included in the formation data.

As an example, the formation display control unit 151 controls the display unit 150 so that the virtual object (the second virtual object) corresponding to the attending member is disposed at the position indicated by the position information corresponding to the attending member (the position of the virtual object). Further, the formation display control unit 151 controls the display unit 150 so that the virtual object (the first virtual object) corresponding to the absent member is disposed at the position (the position of the virtual object) indicated by the position information corresponding to the absent member.

This makes it possible to perform the formation switching according to the music song. This also makes it possible to cope with sudden change in reproduction speed of the music song, frequent pauses in the reproduction of the music song, and the like. The user moves to the position at which the user should be present according to the reproduction of the music song (that is, according to the progress of the time count). In this case, the user can intuitively ascertain the standing position of each member and the temporal change during the formation practice by visually confirming the displayed virtual object.

The position of the virtual object is associated with the time count progressing at a predetermined time interval regardless of whether the virtual object corresponds to the attending member or the absent member. Therefore, there is also time count that is not associated with the position of the virtual object. Therefore, the positions of the virtual object that have not yet been determined may be determined by linear interpolation of positions of a plurality of virtual objects that have already been determined.

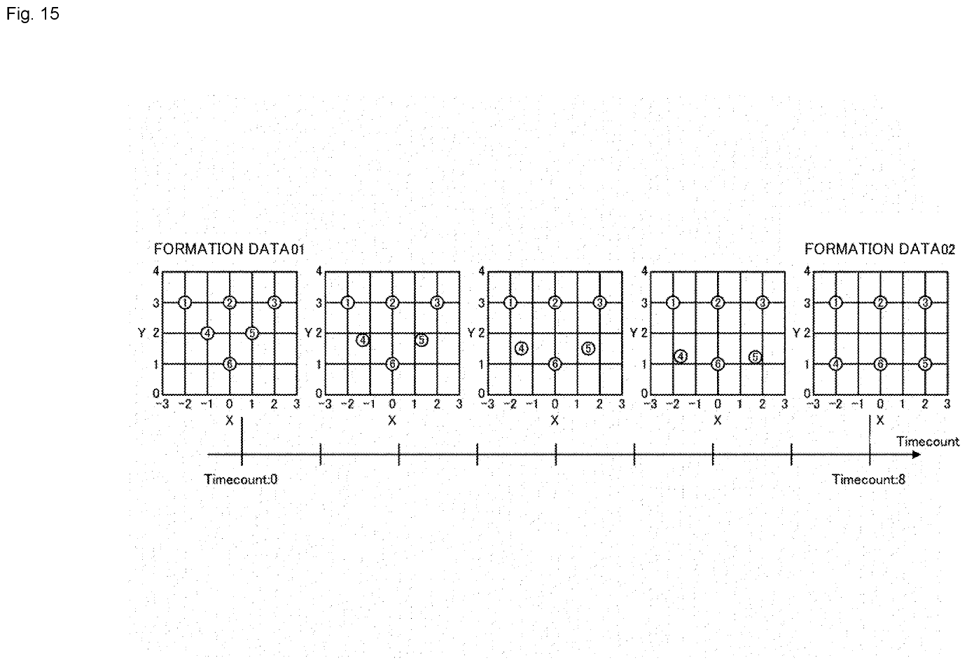

FIG. 15 is a diagram illustrating an example of linear interpolation. In the example illustrated in FIG. 15, it is also assumed that the number of participating users is 6, and the position of each user is indicated as “1” to “6” on the XY coordinates formed by the virtual grid. Each of these users may be an attending member or may be an absent member.

Here, the positions of the six users change as the time count progresses. The position of the virtual object corresponding to each user is associated with time count 0 (the first time). Similarly, the position of the virtual object corresponding to each user is associated with each time count 8 (second time). However, the position of the virtual object corresponding to each user is not associated with each of time counts 1 to 7 between time count 0 and time count 8.

In this case, as illustrated in FIG. 15, the formation display control unit 151 linearly interpolates the position of the virtual object corresponding to each user associated with time count 0 and the position of the virtual object corresponding to each user associated with time count 8 at each of time counts 1 to 7 (third time) (S68).

The formation display control unit 151 may control the display unit 150 so that the virtual object corresponding to each user is disposed at a position (a third disposition position) designated by such linear interpolation. This makes it possible to estimate the position of the virtual object not actually directly input.

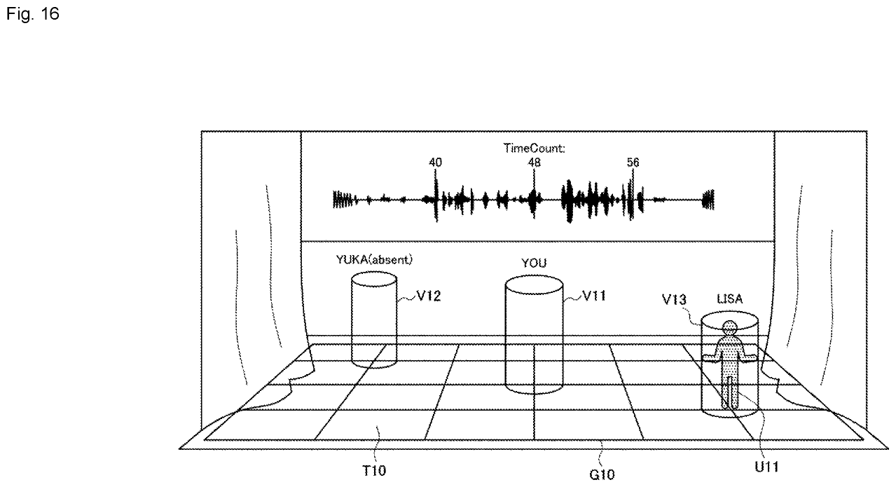

FIG. 16 is a diagram illustrating a display example of the motion of the virtual object being reproduced. Referring to FIG. 16, a stage surface T10 present in the real space is shown. The grid display control unit 152 controls the display unit 150 so that the display unit 150 displays the virtual grid G10 on the stage surface T10 present in the real space. Further, the UI display control unit 153 controls the display unit 150 so that the time count information indicating a current time count (in the example illustrated in FIG. 16, a time after 48 seconds have elapsed since the start of reproduction of the motion of the virtual object) is displayed.

A virtual object V11 is a virtual object corresponding to the user (YOU) who wears the HMD 10 including the display unit 150. A virtual object V13 is a virtual object corresponding to a user U11 (LISA) who is an attending member, and a motion thereof has been input by the user U11 himself or herself. Further, a virtual object V12 is a virtual object corresponding to an absent member (YUKA), and the user U11 who is an attending member has input a motion of the virtual object V13 on the basis of the template data at the same time as input of the motion of the virtual object V13.

The size of the virtual object corresponding to each user is a size based on the body motion range radius corresponding to the user (S72). Since it is assumed here that the virtual object has a cylindrical shape, a radius of the virtual object is equal to the body motion range radius. This makes it possible to display a virtual object whose size (radius) reflects individual difference in body motion range.

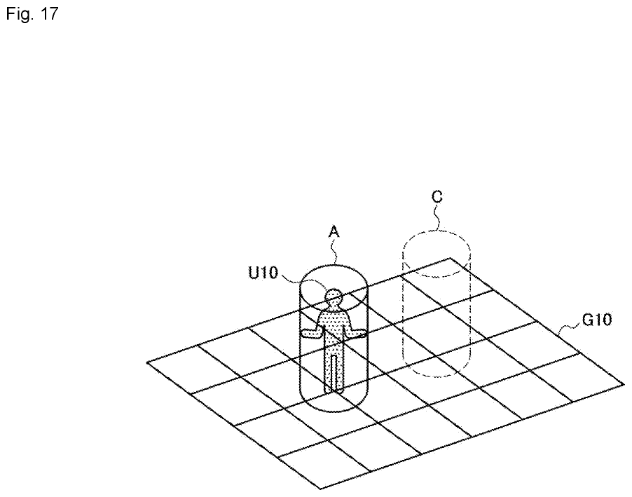

The user can intuitively ascertain the standing position of each member and the temporal change during the formation practice when such a virtual object is displayed. However, in a case in which there is a likelihood that a member will collide with another member, it is conceivable that it is possible to perform formation practice more safely when it is ascertained that there is a likelihood that a member will collide with the other member. Therefore, the likelihood of collision with another member will be described with reference to FIGS. 17 to 19.

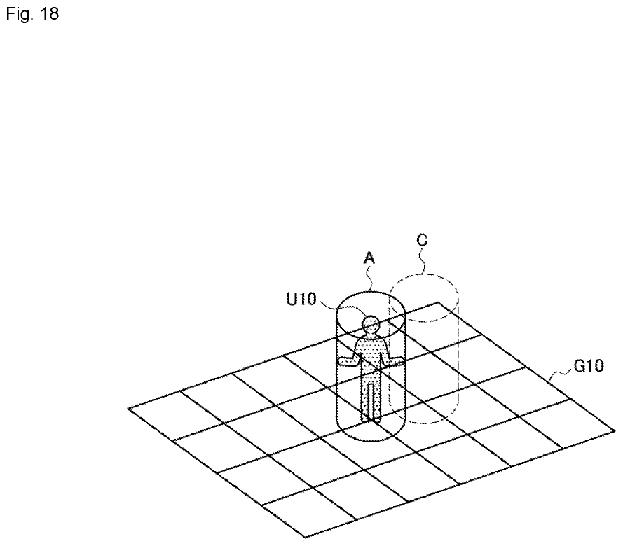

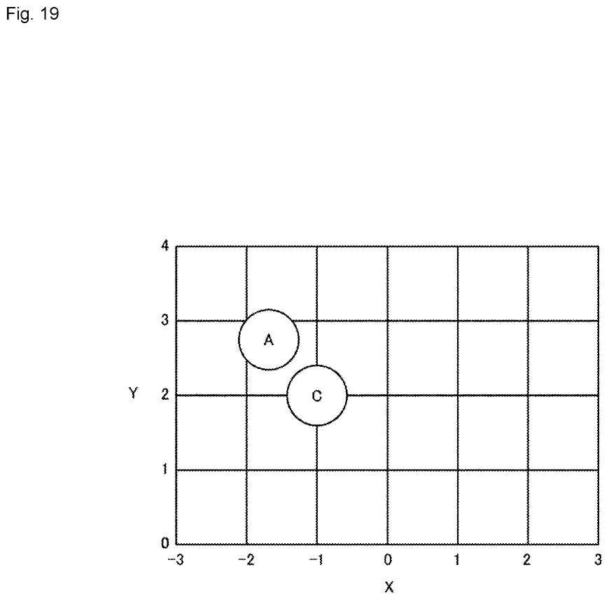

FIG. 17 is a diagram illustrating an example of a case in which a determination is made that there is no likelihood that members will collide. FIG. 18 is a diagram illustrating an example of a case in which a determination is made that there is a likelihood that members will collide. FIG. 19 is a diagram illustrating an example of a determination as to whether or not there is a likelihood that members will collide. A virtual object A is a virtual object (a second virtual object) corresponding to the user U10 who is an attending member. On the other hand, a virtual object C is a virtual object (a first virtual object) corresponding to an absent member.

The UI display control unit 153 controls the display unit 150 so that warning information indicating a likelihood of collision between bodies is displayed when at least a portion of a body motion range of the user U10 (who is an attending member) based on the self-position information of the HMD 10 of the user U10 and the body motion range radius of the user U10 at a predetermined time and at least a portion of the virtual object C corresponding to the absent member overlap (that is, have an overlapping portion).

Here, it is mainly assumed that the predetermined point in time is the time of reproducing the motion of the virtual object (that is, the self-position information of the HMD 10 of the user U10 at the predetermined point in time is current self-position information). Accordingly, the UI display control unit 153 acquires the current self-position information obtained by the SLAM processing unit 121 (S69). However, the predetermined point in time may be s time when disposition positions of the virtual object A corresponding to the attending member and the virtual object C corresponding to the absent member are determined.

In the example illustrated in FIG. 17, the body motion range of the user U10 based on the current self-position of the HMD 10 of the user U10 and the body motion range radius of the user U10 matches the virtual object A corresponding to the user U10. The virtual object A corresponding to the user U10 who is an attending member and the virtual object C corresponding to an absent member do not have an overlapping portion. Therefore, in the example illustrated in FIG. 17, a determination is made that there is no likelihood that members will collide.

In the example illustrated in FIG. 18, the body motion range of the user U10 based on the current self-position of the HMD 10 of the user U10 and the body motion range radius of the user U10 matches the virtual object A corresponding to the user U10. In the example illustrated in FIG. 18, the virtual object A corresponding to the user U10 who is an attending member and the virtual object C corresponding to an absent member have an overlapping portion. Therefore, in the example illustrated in FIG. 18, a determination is made that there is a likelihood that members will collide.

For example, in the example illustrated in FIG. 19, a position of the virtual object A corresponding to the attending member is (XA, YA), the body motion range radius of the attending member is DA, a position of the virtual object C corresponding to the absent member is (XC, YC), and a body motion range radius of the absent member is DC. In this case, whether or not the virtual object A and the virtual object C have an overlapping portion can be determined according to whether or not a distance between (XA, YA) and (XC, YC) is smaller than a sum of DA and DC.

Referring back to FIG. 14, the description continues. The formation data once input may be changeable. In this case, the attending member inputs an operation of selecting desired template data (desired disposition pattern) from the plurality of pieces of template data via the operation unit 180 (S81). The object determination unit 126 determines the disposition position of the virtual object (the second virtual object) corresponding to the attending member himself or herself in the global coordinate system on the basis of the current position of the HMD 10 indicated by the self-position information. The intersection of the virtual grid closest to the current position of the HMD 10 indicated by the self-position information is determined to be the disposition position of the virtual object corresponding to the attending member himself or herself.

Further, the object determination unit 126 acquires the template data selected from the plurality of pieces of template data, and determines the disposition position of the virtual object (the first virtual object) corresponding to the absent member in the global coordinate system on the basis of the self-position information of the HMD 10 of the attending member and the selected template data (S82). In this case, the object determination unit 126 determines the intersection of the virtual grid closest to the point determined according to the current position of the HMD 10 indicated by the self-position information and the template data to be the disposition position of the virtual object corresponding to the absent member.

An order of conversion based on the template data and the grid adsorption (snap to the grid S83) does not matter. That is, the grid adsorption may be first performed on the position at which the attending member has input the determination operation, and then the conversion based on the disposition pattern may be performed. Alternatively, the position at which the attending member has input the determination operation may be converted first on the basis of the disposition pattern, and then the grid adsorption may be performed later.

The object determination unit 126 acquires the information on the time count that has progressed at a speed according to the beat detected by the beat detection processing unit 125, and inputs the time count information to the formation data. Further, the object determination unit 126 inputs the position information of the virtual object corresponding to the attending member and the position information of the virtual object corresponding to the absent member to the formation data together with the position ID as respective position information (S84).

Further, the object determination unit 126 generates formation data by adding the formation ID obtained from the formation information included in the performance data selected by the attending member to the time count information, the position ID, and the position information. The object determination unit 126 records the generated formation data in the storage unit 140 (that is, records the correspondence relationship among the formation ID, the position ID, the time count information, and the position information in the storage unit 140).

Functional details of the HMD 10 according to the embodiment of the present disclosure have been described above.

### 2. Hardware Configuration Example

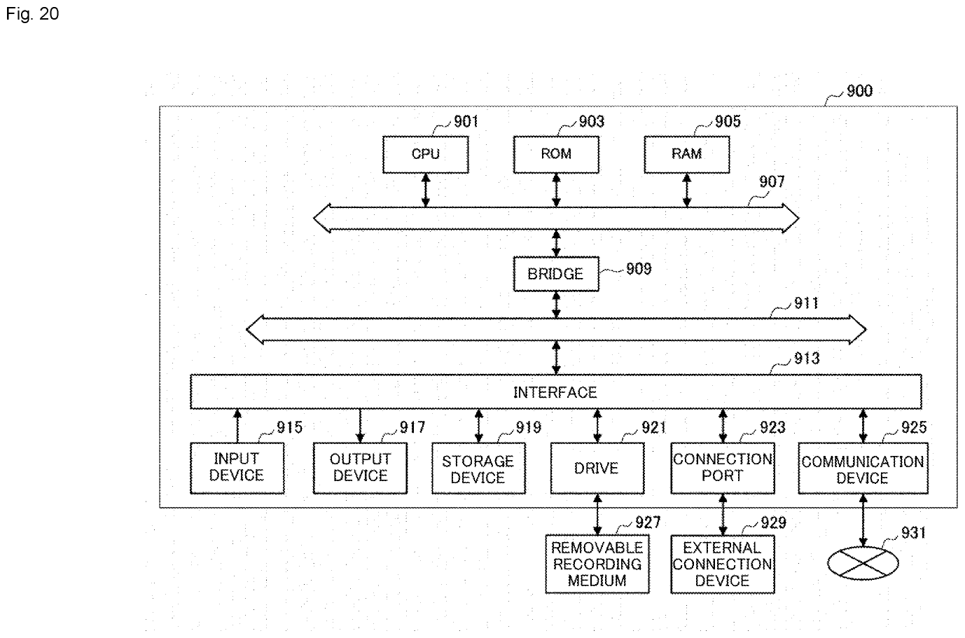

Next, a hardware configuration example of the information processing device 900 as an example of the HMD 10 according to the embodiment of the present disclosure will be described with reference to FIG. 20. FIG. 20 is a block diagram illustrating the hardware configuration example of the information processing device 900. It is not necessary for the HMD 10 to have all of the hardware configuration illustrated in FIG. 20, and part of the hardware configuration illustrated in FIG. 20 may not exist in the HMD 10.

As illustrated in FIG. 20, the information processing device 900 includes a central processing unit (CPU) 901, a read only memory (ROM) 903, and a random access memory (RAM) 905. Further, the information processing device 900 may include a host bus 907, a bridge 909, an external bus 911, an interface 913, an input device 915, an output device 917, a storage device 919, a drive 921, a connection port 923 and a communication device 925. The information processing device 900 may have a processing circuit called a digital signal processor (DSP) or application specific integrated circuit (ASIC) instead of or together with the CPU 901.

The CPU 901 functions as an arithmetic processing device and a control device, and controls all or part of an operation in the information processing device 900 according to various programs recorded in the ROM 903, the RAM 905, the storage device 919, or the removable recording medium 927. The ROM 903 stores programs or calculation parameters used by the CPU 901. The RAM 905 temporarily stores programs used in the execution of the CPU 901, parameters that change appropriately during the execution, and the like. The CPU 901, the ROM 903, and the RAM 905 are interconnected by the host bus 907 configured of an internal bus such as a CPU bus. Further, the host bus 907 is connected to the external bus 911 such as a peripheral component interconnect/interface (PCI) bus via the bridge 909.

The input device 915 is, for example, a device operated by the user, such as a button. The input device 915 may include a mouse, a keyboard, a touch panel, switches, levers, and the like. Further, the input device 915 may also include a microphone that detects a voice of the user. The input device 915 may be, for example, a remote control device using infrared rays or other radio waves, or may be an external connection device 929 such as a mobile phone corresponding to an operation of the information processing device 900. The input device 915 includes an input control circuit that generates an input signal on the basis of information input by the user and outputs the input signal to the CPU 901. The user inputs various pieces of data to the information processing device 900 or instructs processing operations by operating the input device 915. An imaging device 933, which will be described below, can also function as an input device by imaging a motion of a hand of the user, a finger of the user, and the like. In this case, a pointing position may be determined according to a motion of the hand or an orientation of the finger.

The output device 917 is configured of a device capable of visually or audibly notifying the user of acquired information. The output device 917 can be, for example, a display device such as a liquid crystal display (LCD) or an organic electro-luminescence (EL) display, or a sound output device such as a speaker or a headphone. Further, the output device 917 may include a plasma display panel (PDP), a projector, a hologram, a printer device, and the like. The output device 917 outputs a result obtained by processing of the information processing device 900 as text or a video such as an image, or as a sound such as voice or acoustic sound. Further, the output device 917 may also include lights or the like for brightening surroundings.

The storage device 919 is a data storage device configured as an example of the storage unit of the information processing device 900. The storage device 919 is configured of, for example, a magnetic storage device such as a hard disk drive (HDD), a semiconductor storage device, an optical storage device, or a magneto-optical storage device. The storage device 919 stores programs executed by the CPU 901, various pieces of data, various pieces of data acquired from the outside, and the like.

The drive 921 is a reader and writer for the removable recording medium 927 such as a magnetic disk, an optical disc, a magneto-optical disc, or a semiconductor memory, and is built in or externally attached to the information processing device 900. The drive 921 reads information recorded on the attached removable recording medium 927 and outputs the information to the RAM 905. Further, the drive 921 writes records to the attached removable recording medium 927.

The connection port 923 is a port for directly connecting a device to the information processing device 900. The connection port 923 can be, for example, a universal serial bus (USB) port, an IEEE1394 port, or a small computer system interface (SCSI) port. Further, the connection port 923 may be an RS-232C port, an optical audio terminal, an HDMI (registered trademark) (High-Definition Multimedia Interface) port, or the like. A connection of the external connection device 929 to the connection port 923 makes it possible for various pieces of data to be exchanged between the information processing device 900 and the external connection device 929.

The communication device 925 is, for example, a communication interface configured of a communication device for connection to a network 931 or the like. The communication device 925 may be, for example, a communication card for a wired or wireless local area network (LAN), Bluetooth (registered trademark), or a wireless USB (WUSB). Further, the communication device 925 may be a router for optical communication, a router for asymmetric digital subscriber line (ADSL), or any modem for communication. The communication device 925, for example, transmits or receives signals or the like to or from the Internet or another communication device using a predetermined protocol such as TCP/IP. Further, the network 931 connected to the communication device 925 is a wired or wireless network, such as the Internet, home LAN, infrared communication, radio wave communication, or satellite communication.

### 3. Conclusion

According to the embodiment of the present disclosure, an information processing device including: a self-location acquisition unit configured to acquire self-position information of a mobile terminal in a global coordinate system linked to a real space; and a disposition position determination unit configured to acquire template data indicating a disposition pattern of at least one virtual object, and determine a position away from a current position of the mobile terminal indicated by the self-position information as a disposition position of a first virtual object in the global coordinate system, on the basis of the self-position information and the template data is provided.

According to such a configuration, a technology that allows input of a position at which a person who performs a predetermined performance should be present to be easily performed in advance so that the position at which the person should be present is confirmed later is provided.

Although the preferred embodiments of the present disclosure have been described in detail with reference to the accompanying drawings, the technical scope of the present disclosure is not limited to such examples. It is obvious that anyone with ordinary knowledge in the technical field of the present disclosure may conceive various modification examples or change examples within the scope of the technical ideas set forth in the claims and, of course, it is understood that these belong to the technical scope of the present disclosure.

Further, effects described in the present specification are merely descriptive or illustrative and are not limited. That is, the technology according to the present disclosure may exhibit other effects apparent to those skilled in the art from the description in the present specification, in addition to or in place of the above effects.

The following configurations also belong to a technical scope of the present disclosure.

(1) An information processing device including:
a self-location acquisition unit configured to acquire self-position information of a mobile terminal in a global coordinate system linked to a real space; and
a disposition position determination unit configured to acquire template data indicating a disposition pattern of at least one virtual object, and determine a position away from a current position of the mobile terminal indicated by the self-position information as a disposition position of a first virtual object in the global coordinate system, on the basis of the self-position information and the template data.
(2) The information processing device according to (1), including:
a grid setting unit configured to set a virtual grid in the real space on the basis of the self-position information, wherein
the disposition position determination unit determines the disposition position of the first virtual object in association with an intersection of the virtual grid on the basis of the self-position information.
(3) The information processing device according to (2), wherein the disposition position determination unit
determines an intersection of the virtual grid closest to a point determined according to the current position indicated by the self-position information and the template data to be the disposition position of the first virtual object.
(4) The information processing device according to any one of (1) to (3), wherein
the template data includes a plurality of pieces of template data, and the disposition position determination unit
acquires first time count information indicating a first time specified by a user, and
records a correspondence relationship between a first disposition position of the first virtual object specified on the basis of a first disposition pattern indicated by first template data selected from among the plurality of pieces of template data by the user and the current position and the first time count information.
(5) The information processing device according to (4), wherein the disposition position determination unit
acquires second time count information indicating a second time after the first time designated by the user, and
records a correspondence relationship between a second disposition position of the first virtual object specified on the basis of a second disposition pattern of second template data selected from among the plurality of pieces of template data by the user and the current position and the second time count information, and
the information processing device
includes an output control unit configured to control an output device so that the first virtual object is disposed at a third disposition position designated by linearly interpolating between the first disposition position and the second disposition position at a third time between the first time and the second time when the motion of the first virtual object is reproduced.
(6) The information processing device according to any one of (1) to (3), including:
an output control unit configured to control an output device so that the first virtual object is disposed at the disposition position of the first virtual object when the motion of the first virtual object is reproduced.
(7) The information processing device according to (6), wherein the disposition position determination unit
determines the disposition position of the second virtual object in the global coordinate system on the basis of the current position of the mobile terminal indicated by the self-position information.
(8) The information processing device according to (7), wherein the output control unit controls the output device so that the second virtual object is disposed at the disposition position of the second virtual object when the motion of the first virtual object is reproduced.
(9) The information processing device according to (7) or (8), including:
a grid setting unit configured to set a virtual grid in a real space on the basis of the self-position information, wherein
the disposition position determination unit
determines the disposition position of the second virtual object in association with the intersection of the virtual grid on the basis of the self-position information.
(10) The information processing device according to (9), wherein the disposition position determination unit
determines an intersection of the virtual grid closest to the current position indicated by the self-position information as the disposition position of the second virtual object.
(11) The information processing device according to (2) or (9), wherein the virtual grid includes a plurality of straight lines set at a predetermined interval in each of a first direction and a second direction according to a recognition result of a predetermined surface present in the real space.
(12) The information processing device according to any one of (1) to (3), including:
a size determination processing unit configured to determine a size of the first virtual object on the basis of a measurement result of a predetermined length regarding a body of a user corresponding to the first virtual object.
(13) The information processing device according to (12), including: an output control unit configured to control an output device so that warning information indicating a likelihood of a collision between bodies is output when at least a portion of a body motion range of the user based on the self-position information of the mobile terminal at a predetermined point in time and a measurement result for a predetermined length regarding the body of the user and at least a portion of the first virtual object overlap at the time of reproduction of a motion of the first virtual object.
(14) The information processing device according to (13), wherein the predetermined point in time is a time when the motion of the first virtual object is reproduced.
(15) The information processing device according to (13), wherein the predetermined point in time is a time when the disposition position of the first virtual object is determined.
(16) The information processing device according to any one of (1) to (15), wherein
the time count information associated with the disposition position of the first virtual object is information associated with music data.
(17) The information processing device according to (16), including:
a beat detection processing unit configured to detect a beat of the music data on the basis of reproduced sound of the music data detected by the microphone,
wherein the disposition position determination unit
records a correspondence relationship between information on time count progressing at a speed according to the beat and the disposition position of the first virtual object.
(18) An information processing method including:
acquiring self-position information of a mobile terminal in a global coordinate system linked to a real space; and
acquiring template data indicating a disposition pattern of at least one virtual object, and determining a position away from a current position of the mobile terminal indicated by the self-position information as a disposition position of a first virtual object in the global coordinate system, on the basis of the self-position information and the template data.
(19) A computer-readable recording medium having a program recorded thereon, the program causing a computer to function as an information processing device including:
a self-location acquisition unit configured to acquire self-position information of a mobile terminal in a global coordinate system linked to a real space; and
a disposition position determination unit configured to acquire template data indicating a disposition pattern of at least one virtual object, and determine a position away from a current position of the mobile terminal indicated by the self-position information as a disposition position of a first virtual object in the global coordinate system, on the basis of the self-position information and the template data.

### REFERENCE SIGNS LIST

10 HMD
110 Sensor unit
111 Recognition camera
112 Gyro sensor
113 Acceleration sensor
114 Orientation sensor
115 Microphone
120 Control unit
121 SLAM processing unit
122 Device posture processing unit
123 Stage grid formation processing unit
124 Hand recognition processing unit
125 Beat detection processing unit
126 Object determination unit
130 Content reproduction unit
140 Storage unit
141 Performance data
142 Formation data
143 User data
144 Stage data
150 Display unit
151 Formation display control unit
152 Grid display control unit
153 UI display control unit
153 Grid display control unit
160 Speaker
170 Communication unit
180 Operation unit

1. An information processing device comprising:
a self-location acquisition unit configured to acquire self-position information of a mobile terminal in a global coordinate system linked to a real space; and
a disposition position determination unit configured to acquire template data indicating a disposition pattern of at least one virtual object, and determine a position away from a current position of the mobile terminal indicated by the self-position information as a disposition position of a first virtual object in the global coordinate system, on the basis of the self-position information and the template data.

2. The information processing device according to claim 1, comprising:
a grid setting unit configured to set a virtual grid in the real space on the basis of the self-position information, wherein
the disposition position determination unit determines the disposition position of the first virtual object in association with an intersection of the virtual grid on the basis of the self-position information.

3. The information processing device according to claim 2, wherein the disposition position determination unit
determines an intersection of the virtual grid closest to a point determined according to the current position indicated by the self-position information and the template data to be the disposition position of the first virtual object.

4. The information processing device according to claim 1, wherein the template data includes a plurality of pieces of template data, and the disposition position determination unit
acquires first time count information indicating a first time specified by a user, and
records a correspondence relationship between a first disposition position of the first virtual object specified on the basis of a first disposition pattern indicated by first template data selected from among the plurality of pieces of template data by the user and the current position and the first time count information.

5. The information processing device according to claim 4, wherein the disposition position determination unit
acquires second time count information indicating a second time after the first time designated by the user, and
records a correspondence relationship between a second disposition position of the first virtual object specified on the basis of a second disposition pattern of second template data selected from among the plurality of pieces of template data by the user and the current position and the second time count information, and
the information processing device
includes an output control unit configured to control an output device so that the first virtual object is disposed at a third disposition position designated by linearly interpolating between the first disposition position and the second disposition position at a third time between the first time and the second time when the motion of the first virtual object is reproduced.

6. The information processing device according to claim 1, comprising:
an output control unit configured to control an output device so that the first virtual object is disposed at the disposition position of the first virtual object when the motion of the first virtual object is reproduced.

7. The information processing device according to claim 6, wherein the disposition position determination unit
determines the disposition position of the second virtual object in the global coordinate system on the basis of the current position of the mobile terminal indicated by the self-position information.

8. The information processing device according to claim 7, wherein the output control unit
controls the output device so that the second virtual object is disposed at the disposition position of the second virtual object when the motion of the first virtual object is reproduced.

9. The information processing device according to claim 7, comprising:
a grid setting unit configured to set a virtual grid in a real space on the basis of the self-position information, wherein
the disposition position determination unit
determines the disposition position of the second virtual object in association with an intersection of the virtual grid on the basis of the self-position information.

10. The information processing device according to claim 9, wherein the disposition position determination unit
determines an intersection of the virtual grid closest to the current position indicated by the self-position information as the disposition position of the second virtual object.

11. The information processing device according to claim 2, wherein the virtual grid includes a plurality of straight lines set at a predetermined interval in each of a first direction and a second direction according to a recognition result of a predetermined surface present in the real space.

12. The information processing device according to claim 1, comprising:
a size determination processing unit configured to determine a size of the first virtual object on the basis of a measurement result of a predetermined length regarding a body of a user corresponding to the first virtual object.

13. The information processing device according to claim 12, comprising:
an output control unit configured to control an output device so that warning information indicating a likelihood of a collision between bodies is output when at least a portion of a body motion range of the user based on the self-position information of the mobile terminal at a predetermined point in time and a measurement result for a predetermined length regarding the body of the user and at least a portion of the first virtual object overlap at the time of reproduction of a motion of the first virtual object.

14. The information processing device according to claim 13, wherein the predetermined point in time is a time when the motion of the first virtual object is reproduced.

15. The information processing device according to claim 13, wherein the predetermined point in time is a time when the disposition position of the first virtual object is determined.

16. The information processing device according to claim 1, wherein time count information associated with the disposition position of the first virtual object is information associated with music data.

17. The information processing device according to claim 16, comprising:
a beat detection processing unit configured to detect a beat of the music data on the basis of reproduced sound of the music data detected by the microphone,
wherein the disposition position determination unit
records a correspondence relationship between information on time count progressing at a speed according to the beat and the disposition position of the first virtual object.

18. An information processing method comprising:
acquiring self-position information of a mobile terminal in a global coordinate system linked to a real space; and
acquiring template data indicating a disposition pattern of at least one virtual object, and determining a position away from a current position of the mobile terminal indicated by the self-position information as a disposition position of a first virtual object in the global coordinate system, on the basis of the self-position information and the template data.

19. A computer-readable recording medium having a program recorded thereon, the program causing a computer to function as an information processing device comprising:
a self-location acquisition unit configured to acquire self-position information of a mobile terminal in a global coordinate system linked to a real space; and
a disposition position determination unit configured to acquire template data indicating a disposition pattern of at least one virtual object, and determine a position away from a current position of the mobile terminal indicated by the self-position information as a disposition position of a first virtual object in the global coordinate system, on the basis of the self-position information and the template data.
